(19) United States
(12) Patent Application Publication
(10) Pub. No.: US 2026/0128039 A1
(43) Pub. Date: May 7, 2026

(54) ENABLING CUSTOM WORD IDENTIFICATION IN SPEECH-TO-TEXT MODELS

(71) Applicant: Micro Focus LLC, Wilmington, DE (US)

(72) Inventors: Sean Mark Blanchflower, Cambridge (GB); Wenting Zhang, Cambridge (GB)

(73) Assignee: Micro Focus LLC, Wilmington, DE (US)

(21) Appl. No.: 18/938,543

(22) Filed: Nov. 6, 2024

(51) Int. Cl. G10L 15/183; G10L 15/26

(52) U.S. Cl. CPC G10L 15/183; G10L 15/26

(57) ABSTRACT

Language models require resource-intensive training. As a result, retraining language models happens very infrequently even though new or custom words are needed at a much faster rate. By deploying a custom set of words, speech recognition may be performed using a previously trained language model and augmented with entries in a custom word list. A probability map is created for each token position predicted by the model. Next, potential positions for custom words are identified by calculating the probability ratio between the token selected by the model and the custom word token. The probability ratios are summed for the first, second, and last tokens of the custom words, and if the sum falls below a certain threshold, the position is recorded. Next, the word or words starting at the recorded position are identified and, using string comparison metrics, are determined the most likely candidates for replacement.

### FIELD OF THE DISCLOSURE

The invention relates generally to systems and methods for automated speech recognition and particularly to supplementing a previously trained language model with custom words without retraining the model.

### BACKGROUND

Understanding human speech is complex and nuanced, whether for humans or machines. Humans may have accents, different speeds of talking, and other differences that complicate understanding of spoken language. Humans may say the same words or sounds with different meanings, meanings of words may change based on inflection, and other nuanced speech patterns may exist or be present without intending to change the meaning.

Humans are well adapted to recognize the context of speech, although misunderstandings still occur. When speech is heard and believed to be accurately understood, the context of the speech may provide a different meaning or, if nothing else, indicate a lack of certainty to the listener.

The prior art speech recognition techniques have advanced from user-specific training to become adaptable to a broader range of individuals and their particular speaking patterns. Large language models (LLMs) are commonly used to enable computer systems to perform speech recognition. However, training such a model represents a very significant investment in computing hardware and operating such hardware; even the electricity required to train an LLM can be a substantial cost. As a result, once an LLM is trained, it will likely not be retrained for some time. Human speech is always advancing, and the need to add new words to an LLM begins almost as soon as training ends. As a result, automated speech recognition systems are often out of date and fail to recognize words other than those used in the training set.

### SUMMARY

Modern speech recognition systems, in particular LLM-based systems, are well adapted to handle speech consisting of words known at the time the LLM was trained. New words are commonly introduced in the form of product names and individuals, such as government or business officials with obscure names. As a result, computer-recognized speech often requires extensive manual correction or may be unusable due to an unacceptable level of errors, especially if the error is to a word or phrase that is key to a discussion.

These and other needs are addressed by the various embodiments and configurations of the present invention. The present invention can provide a number of advantages depending on the particular configuration. These and other advantages will be apparent from the disclosure of the invention(s) contained herein.

In one embodiment, an extensible system for allowing speech-to-text of custom words and phrases is disclosed. The custom words may include, but are not limited to, peoples' names, locations, or company and product names that are not present in the training data.

In another embodiment, an existing trained model can be augmented at run-time to look for custom words. First, a probability map is created for each token (usually a word) position predicted by the model. Next, potential positions for custom words are identified by calculating the probability ratio between the token selected by the model and the custom word token. The probability ratios for the first, second and last tokens of the custom words are summed and, if the sum falls below a certain threshold, the position is recorded. Next, the word or words starting at the recorded position are identified and, using string comparison metrics, determine, such as by a processor, the most likely candidates for replacement. As a benefit, the metrics help to ensure that the word being replaced closely matches the custom word, reducing the risk of false positives.

In some aspects, the techniques described herein relate to a method, including: accessing speech to be recognized; providing the speech to a previously trained language model and receiving a first set of tokens therefrom; providing the speech to a custom language model and receiving a second set of tokens therefrom; determining a position within the speech where a token of the second set of tokens is a better fit than a token of the first set of tokens; and replacing a default word of the speech, determined by the previously trained language model, with a custom word at the position.

In some aspects, the techniques described herein relate to a method, wherein: determining the position within the speech where the token of the second set of tokens is the better fit than the token of the first set of tokens includes determining the position within the speech where a first ratio is greater than a second ratio; the first ratio is determined by summing probability ratios of less than all tokens of the custom word; and determining the position in the speech includes determining where in the speech the first ratio is below a previously determined threshold.

In some aspects, the techniques described herein relate to a method, wherein summing the probability ratios of less than all tokens of the custom word includes summing the probability ratios of a first token, a second token, and a last token of the custom word.

In some aspects, the techniques described herein relate to a method, wherein replacing the default word of the speech determined by the previously trained language model with the custom word at the position further includes using string comparison metrics to select a best match of a set of custom words, including the custom word, to a word at the position.

In some aspects, the techniques described herein relate to a method, wherein replacing the word with the custom word at the position further includes providing the custom word as a portion of a transcription.

In some aspects, the techniques described herein relate to a method, wherein replacing the default word with the custom word at the position further includes providing the custom word as a portion of a command to a computing device.

In some aspects, the techniques described herein relate to a method, wherein the previously trained language model includes at least one of a large language model or a neural network trained to recognize a generic set of words.

In some aspects, the techniques described herein relate to a method, wherein at least one of the default word and the custom word include a plurality of words.

In some aspects, the techniques described herein relate to a system, including: a computing device including one or more processors coupled to a computer memory including instructions; and wherein the instructions, when read by the one or more processors, cause the one or more processors to perform: accessing speech to be recognized; providing the speech to a previously trained language model and receiving a first set of tokens therefrom; providing the speech to a custom language model and receiving a second set of tokens therefrom; determining a position within the speech where a token of the second set of tokens is a better fit than a token of the first set of tokens; and replacing a default word of the speech, determined by the previously trained language model, with a custom word at the position.

In some aspects, the techniques described herein relate to a system, wherein: determining the position within the speech where the token of the second set of tokens is the better fit than the token of the first set of tokens includes determining the position within the speech where a first ratio is greater than a second ratio; the first ratio is determined by summing probability ratios of less than all tokens of the custom word; and determining the position in the speech includes determining where in the speech the first ratio is below a previously determined threshold.

In some aspects, the techniques described herein relate to a system, wherein summing the probability ratios of less than all tokens of the custom word includes summing the probability ratios of a first token, the second token, and a last token of the custom word.

In some aspects, the techniques described herein relate to a system, wherein replacing the default word of the speech determined by the previously trained language model with the custom word at the position further includes using string comparison metrics to select a best match of a set of custom words, including the custom word, to a word at the position.

In some aspects, the techniques described herein relate to a system, wherein replacing the default word with the custom word at the position further includes providing the custom word as a portion of a transcription.

In some aspects, the techniques described herein relate to a system, wherein replacing the default word with the custom word at the position further includes providing the custom word as a portion of a command to a computing device.

In some aspects, the techniques described herein relate to a system, wherein the previously trained language model includes at least one of a large language model or a neural network trained to recognize a generic set of words.

In some aspects, the techniques described herein relate to a system, wherein at least one of the default word and the custom word include a plurality of words.

In some aspects, the techniques described herein relate to a non-transitory computer readable medium including instructions that, when read by a machine, cause the machine to perform: accessing speech to be recognized; providing the speech to a previously trained language model and receiving a first set of tokens therefrom; providing the speech to a custom language model and receiving a second set of tokens therefrom; determining a position within the speech where a token of the second set of tokens is a better fit than a token of the first set of tokens; and replacing a default word of the speech, determined by the previously trained language model, with a custom word at the position.

In some aspects, the techniques described herein relate to a non-transitory computer readable medium, further including instructions to cause the machine to perform: determining the position within the speech where the token of the second set of tokens is the better fit than the token of the first set of tokens including determining the position within the speech where a first ratio is greater than a second ratio; the first ratio is determined by summing probability ratios of less than all tokens of a custom word; and determining the position in the speech includes determining where in the speech the first ratio is below a previously determined threshold.

In some aspects, the techniques described herein relate to a non-transitory computer readable medium, further including instructions to cause the machine to perform summing the probability ratios of less than all tokens of the custom word including summing the probability ratios of a first token, a second token, and a last token of the custom word.

In some aspects, the techniques described herein relate to a non-transitory computer readable medium, further including instructions to cause the machine to perform replacing the default word of the speech determined by the previously trained language model with the custom word at the position, further including using string comparison metrics to select a best match of a set of custom words, including the custom word, to a word at the position.

In some aspects, the techniques described herein relate to a non-transitory computer readable medium, further including instructions to cause the machine to perform replacing the word of the speech determined by the previously trained language model with the custom word at the position, further includes using string comparison metrics to select a best match of a set of custom words, including the custom word, to a word at the position.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.), or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a processing overview in accordance with embodiments of the present disclosure;

FIG. 3 depicts a process in accordance with embodiments of the present disclosure; and

FIG. 4 depicts a device of a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

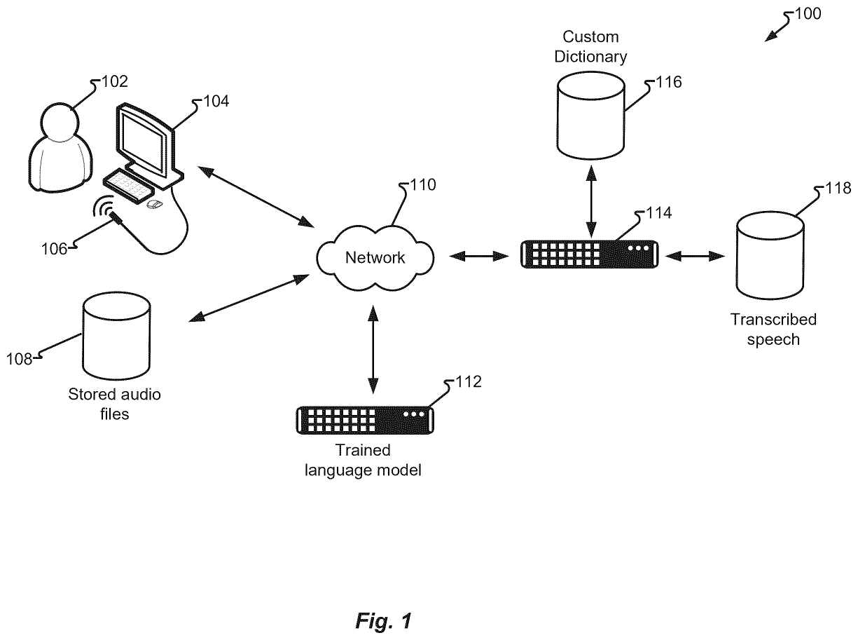

FIG. 1 illustrates system 100 in accordance with embodiments of the present disclosure. In one embodiment, system 100 illustrates components comprising computing components interconnected, such as via network 110. It should be appreciated that system 100 illustrates components in one topology but as those of ordinary skill in the art will appreciate, other topologies may be deployed without departing from the scope of embodiments herein. For example, any one component may be embodied as a plurality of components and/or two or more components may be embodied as a single component. In one embodiment, the components as illustrated perform a single function; in other embodiments, one or more components may perform a plurality of functions and/or one or more functions may be performed by a plurality of components including as a service (e.g., software as a service (SaaS)). In yet another embodiment, the connection topology may be the topology as illustrated in system 100, or another topology without departing from the scope of the embodiments.

System 100 is directed to perform speech-to-text (“STT”) transcription, however, other uses for recognized speech are also contemplated herein. While recognition of speech may be performed to transcribe the speech, recognized speech may be utilized as a command, query, or other input to a speech-recognizing computing device (not shown) to operate such a device.

Speech may be generated in real time, such as user 102 utilizing computer 104 configured with audio inputs and comprising or using microphone 106 to receive speech from user 102. Computer 104 may be any computing device (e.g., mobile phone, laptop, etc.) having microphone 106. User 102 may be using computer 104 to dictate or transcribe speech or as part of a conference with two or more other users (not shown). Speech may be previously recorded and maintained as a sound file in database 108 for subsequent transcription.

Server 112 executes a trained language model having a set of previously processed words and/or phrases. In one embodiment, server 112 executes a large language model (LLM) having been trained on a collection of words and phrases. Server 114 may manage the transcription, such as to receive text from server 112 of transcribed speech. Additionally, server 114 may access custom dictionary database 116 comprising words absent from server 112. Server 114 then utilizes the output of server 112 in conjunction with words from custom database 118 to produce transcribed speech for storage in database 118 or for another purpose, as is described more completely with respect to the embodiments that follow.

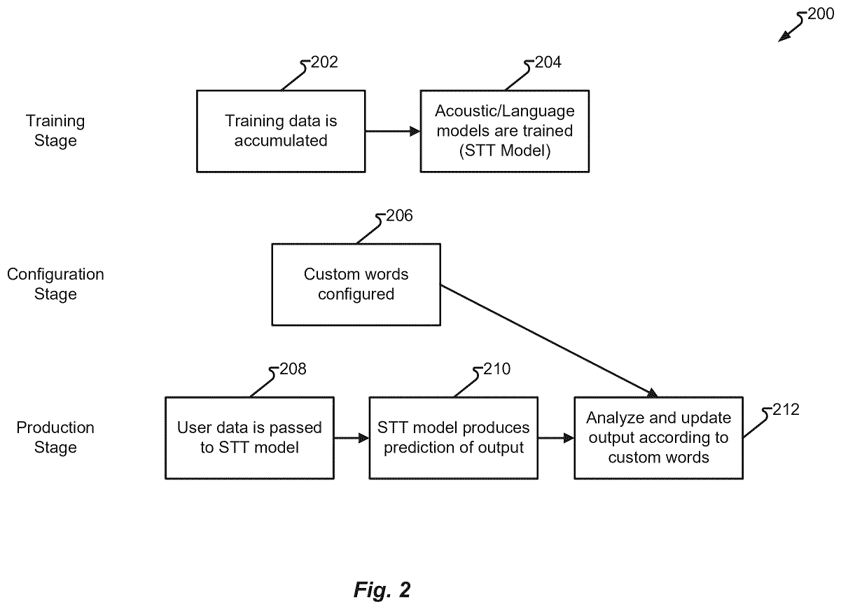

FIG. 2 depicts processing overview 200 in accordance with embodiments of the present disclosure. During a training stage, step 202 accumulates training data. Training data may be obtained from private and public sources to train, in step 204, one or more acoustic/language models. In one embodiment, the outcome of step 204 is a large language model operable to receive speech and produce text. However, such functionality is limited to those words provided in step 202.

The configuration stage comprises step 206 wherein custom words are configured. Step 206 receives speech and/or text of words for a custom dictionary that are, or are reasonably likely to be, absent from the training data provided in step 202. Words added in step 206 may include, but are not limited to, names of people and places, product names, project names, and/or other words absent from the training data.

The production stage then utilizes the speech-to-text (STT) model (produced in step 204) and the custom words (produced in step 206). Step 208 receives user data, such as speech, to recognize for transcription or other purpose. Step 210 then utilizes the STT model to produce a prediction of the output, such as a probability map of each token. A token is, in one embodiment, a distinct acoustic-phonetic attribute that describes a unit of speech. Commonly, a token is a word but may vary in size from a single syllable or phoneme to multiple syllables or words. A speech tokenizer converts speech utterances into a sequence of tokens. The probability map predicts a likelihood of each token within a given position in the speech. For example, speech discussing “President Joe” would have a higher probability of being followed by the (tokenized) name “Biden,” assuming “Joe Biden” is part of the LLM training data in step 202. If such a name was not in the training data, another word, such as the last name of a president of a corporation or a president of another country, may be selected.

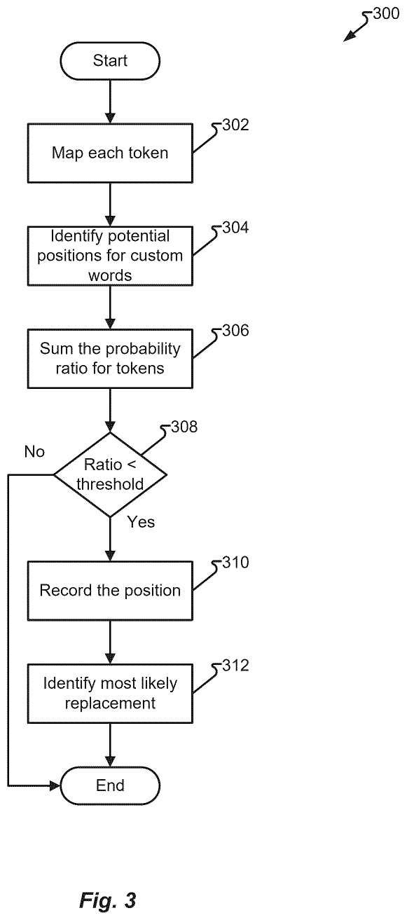

FIG. 3 depicts process 300 in accordance with embodiments of the present disclosure. In one embodiment, process 300 is embodied as machine-readable instructions maintained in a non-transitory memory that when read by a machine, such as one or more processors of a server or servers, cause the machine to execute the instructions and thereby execute process 300. The processor of the server may include, but is not limited to, at least one processor of server 114 and/or server 112.

Speech is received, such as via a real-time input from a user (e.g., user 102 using computer 104 with microphone 106) or a previously recorded audio file (e.g., an audio file in database 108). The speech may first be tokenized and, in step 302, each token is mapped to a position within the speech. Any single token with have a particular frequency of appearance within the speech. For example, the word “yesterday” may be tokenized into one or more tokens. It is more likely that the next set of one or more tokens will be associated with words such as “morning,” “afternoon,” “evening,” etc. than other words, such as “desk” or “concrete.”

Step 304 then identifies one or more potential positions for custom words. The position is identified based on a determined fit of the custom word over the suggested word from the previously trained model. Next, step 306 calculates a probability ratio between the token(s) of the custom word at the position. For example, the ratios of the first, second, and last tokens of the custom word at the position are summed. If test 308 determines that the sum falls below a previously determined threshold, the position of the word (or words) at that position is recorded for later substitution in step 310. Step 312 then identifies the word or words starting at the position identified in step 304 for replacement. Step 312, in one embodiment, utilizes string comparison metrics to determine the most likely candidate for replacement. The most likely candidate of the custom words then replaces the generic word from the previously trained model.

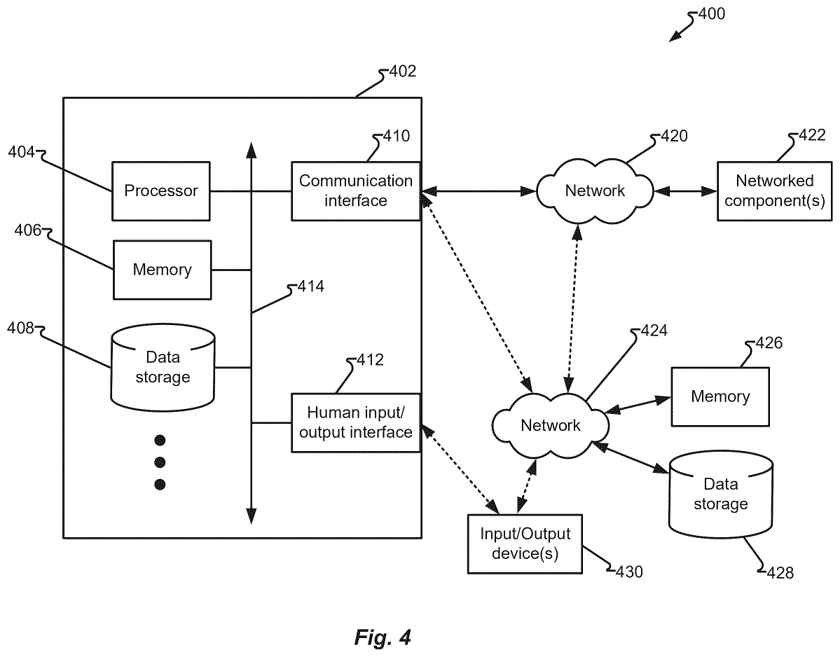

FIG. 4 depicts device 402 in system 400 in accordance with embodiments of the present disclosure. In one embodiment, computer 104, server 112, and/or server 114 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414 and may be embodied as a network interface (e.g., ethernet card, wireless networking components, USB port, etc.). Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 110 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
accessing speech to be recognized;
providing the speech to a previously trained language model and receiving a first set of tokens therefrom;
providing the speech to a custom language model and receiving a second set of tokens therefrom;
determining a position within the speech where a token of the second set of tokens is a better fit than a token of the first set of tokens; and
replacing a default word of the speech, determined by the previously trained language model, with a custom word at the position.

2. The method of claim 1, wherein:
determining the position within the speech where the token of the second set of tokens is the better fit than the token of the first set of tokens comprises determining the position within the speech where a first ratio is greater than a second ratio;
the first ratio is determined by summing probability ratios of less than all tokens of the custom word; and
determining the position in the speech comprises determining where in the speech the first ratio is below a previously determined threshold.

3. The method of claim 2, wherein summing the probability ratios of less than all tokens of the custom word comprises summing the probability ratios of a first token, a second token, and a last token of the custom word.

4. The method of claim 1, wherein replacing the default word of the speech determined by the previously trained language model with the custom word at the position further comprises using string comparison metrics to select a best match of a set of custom words, comprising the custom word, to a word at the position.

5. The method of claim 1, wherein replacing the word with the custom word at the position further comprises providing the custom word as a portion of a transcription.

6. The method of claim 1, wherein replacing the default word with the custom word at the position further comprises providing the custom word as a portion of a command to a computing device.

7. The method of claim 1, wherein the previously trained language model comprises at least one of a large language model or a neural network trained to recognize a generic set of words.

8. The method of claim 1, wherein at least one of the default word and the custom word comprise a plurality of words.

9. A system, comprising:
a computing device comprising one or more processors coupled to a computer memory comprising instructions; and
wherein the instructions, when read by the one or more processors, cause the one or more processors to perform:
accessing speech to be recognized;
providing the speech to a previously trained language model and receiving a first set of tokens therefrom;
providing the speech to a custom language model and receiving a second set of tokens therefrom;
determining a position within the speech where a token of the second set of tokens is a better fit than a token of the first set of tokens; and
replacing a default word of the speech, determined by the previously trained language model, with a custom word at the position.

10. The system of claim 9, wherein:
determining the position within the speech where the token of the second set of tokens is the better fit than the token of the first set of tokens comprises determining the position within the speech where a first ratio is greater than a second ratio;
the first ratio is determined by summing probability ratios of less than all tokens of the custom word; and
determining the position in the speech comprises determining where in the speech the first ratio is below a previously determined threshold.

11. The system of claim 10, wherein summing the probability ratios of less than all tokens of the custom word comprises summing the probability ratios of a first token, the second token, and a last token of the custom word.

12. The system of claim 9, wherein replacing the default word of the speech determined by the previously trained language model with the custom word at the position further comprises using string comparison metrics to select a best match of a set of custom words, comprising the custom word, to a word at the position.

13. The system of claim 9, wherein replacing the default word with the custom word at the position further comprises providing the custom word as a portion of a transcription.

14. The system of claim 9, wherein replacing the default word with the custom word at the position further comprises providing the custom word as a portion of a command to a computing device.

15. The system of claim 9, wherein the previously trained language model comprises at least one of a large language model or a neural network trained to recognize a generic set of words.

16. The system of claim 9, wherein at least one of the default word and the custom word comprise a plurality of words.

17. A non-transitory computer readable medium comprising instructions that, when read by a machine, cause the machine to perform:
accessing speech to be recognized;
providing the speech to a previously trained language model and receiving a first set of tokens therefrom;
providing the speech to a custom language model and receiving a second set of tokens therefrom;
determining a position within the speech where a token of the second set of tokens is a better fit than a token of the first set of tokens; and
replacing a default word of the speech, determined by the previously trained language model, with a custom word at the position.

18. The non-transitory computer readable medium of claim 17, further comprising instructions to cause the machine to perform:
determining the position within the speech where the token of the second set of tokens is the better fit than the token of the first set of tokens comprising determining the position within the speech where a first ratio is greater than a second ratio;
the first ratio is determined by summing probability ratios of less than all tokens of a custom word; and
determining the position in the speech comprises determining where in the speech the first ratio is below a previously determined threshold.

19. The non-transitory computer readable medium of claim 18, further comprising instructions to cause the machine to perform summing the probability ratios of less than all tokens of the custom word comprising summing the probability ratios of a first token, a second token, and a last token of the custom word.

20. The non-transitory computer readable medium of claim 17, further comprising instructions to cause the machine to perform replacing the default word of the speech determined by the previously trained language model with the custom word at the position, further comprising using string comparison metrics to select a best match of a set of custom words, comprising the custom word, to a word at the position.
